(19) United States
(12) Patent Application Publication
(10) Pub. No.: US 2010/0157821 A1
(43) Pub. Date: Jun. 24, 2010

(54) Methods, Systems, And Computer Program Products For Sending Data Units Based On A Measure Of Energy

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/338,494

(22) Filed: Dec. 18, 2008

(51) Int. Cl. G06F 11/30

(52) U.S. Cl. 370/252

(57) ABSTRACT

Methods and systems are described for sending data units based on a measure of energy. In one aspect, a data unit sent to a destination node is received at a receiving network node. A measure of energy needed to successfully send data to the destination node is determined for each of at least one of a plurality of destination network paths available for routing the data to the destination node. Each destination network path includes a respective plurality of nodes having an energy expenditure and an effective rate of data transmission contributing to the measure of energy needed to successfully send data to the destination node. Any transmission of the corresponding data unit to a next one of the network nodes along the one of the plurality of destination network paths is determined based on the determined measure of energy needed to successfully send data.

### RELATED APPLICATIONS

This application is related to U.S. Pat. No. 7,242,920, titled “Methods, Systems, And Computer Program Products For Controlling Data Transmission Based On Power Cost”, filed on May 31, 2005; U.S. patent application Ser. No. 11/763,805, titled “Methods, Systems, And Computer Program Products For Controlling Data Transmission Based On Power Cost”, filed on Jun. 15, 2007, which is a continuation of U.S. Pat. No. 7,242,920; and U.S. patent application Ser. No. 11/937,813, titled “Methods, Systems, And Computer Program Products For Controlling Data Transmission Based On Power Cost”, filed on Nov. 9, 2007; the entire disclosures of which each is here incorporated by reference.

### BACKGROUND

While the cost of computing and communications continues to fall, the price of energy continues to rise. Conditions on communications networks, whether wired, wireless, or a combination, vary over time, which affects network throughput and other factors that, in turn affect the amount of energy required to transmit data through the communication network from a sending device to a receiving device.

Accordingly, there exists a need for methods, systems, and computer program products for sending data units based on a measure of energy.

### SUMMARY

In one aspect, a method for sending data units based on a measure of energy includes receiving, at a receiving network node, a data unit sent to a destination node. A measure of energy needed to successfully send data to the destination node is determined for each of at least one of a plurality of destination network paths available for routing the data to the destination node, each destination network path including a respective plurality of nodes having an energy expenditure and an effective rate of data transmission contributing to the measure of energy needed to successfully send data to the destination node. Whether to transmit a data unit corresponding to the received data unit along any one of the plurality of destination network paths is determined based on the determined measure of energy needed to successfully send data. The corresponding data unit is transmitted to a next one of the respective plurality of network nodes along the one of the plurality of destination network paths responsive to a determination to transmit the corresponding data unit along one of the plurality of destination network paths. At least one of the preceding actions is performed on at least one electronic hardware component.

In another aspect, a system for sending data units based on a measure of energy includes means for receiving, at a receiving network node, a data unit sent to a destination node; means for determining a measure of energy needed to successfully send data to the destination node for each of at least one of a plurality of destination network paths available for routing the data to the destination node, each destination network path including a respective plurality of nodes having an energy expenditure and an effective rate of data transmission contributing to the measure of energy needed to successfully send data to the destination node; means for determining, based on the determined measure of energy needed to successfully send data, whether to transmit a data unit corresponding to the received data unit along any one of the plurality of destination network paths; and means for, responsive to a determination to transmit the corresponding data unit along one of the plurality of destination network paths, transmitting the corresponding data unit to a next one of the respective plurality of network nodes along the one of the plurality of destination network paths. At least one of the means includes at least one electronic hardware component.

In another aspect, a system for sending data units based on a measure of energy includes system components including a network subsystem component configured to receive, at a receiving network node, a data unit sent to a destination node; a routing engine component configured to determine a measure of energy needed to successfully send data to the destination node for each of at least one of a plurality of destination network paths available for routing the data to the destination node, each destination network path including a respective plurality of nodes having an energy expenditure and an effective rate of data transmission contributing to the measure of energy needed to successfully send data to the destination node; a forwarding engine component configured to determine, based on the determined measure of energy needed to successfully send data, whether to transmit a data unit corresponding to the received data unit along any one of the plurality of destination network paths; and the network subsystem component configured to, responsive to a determination to transmit the corresponding data unit along one of the plurality of destination network paths, transmitting the corresponding data unit to a next one of the respective plurality of network nodes along the one of the plurality of destination network paths. At least one of the system components includes at least one electronic hardware component.

In another aspect, a computer readable medium stores a computer program, executable by a machine, for sending data units based on a measure of energy. The computer program includes executable instructions for: receiving, at a receiving network node, a data unit sent to a destination node; determining a measure of energy needed to successfully send data to the destination node for each of at least one of a plurality of destination network paths available for routing the data to the destination node, each destination network path including a respective plurality of nodes having an energy expenditure and an effective rate of data transmission contributing to the measure of energy needed to successfully send data to the destination node; determining, based on the determined measure of energy needed to successfully send data, whether to transmit a data unit corresponding to the received data unit along any one of the plurality of destination network paths; and responsive to a determination to transmit the corresponding data unit along one of the plurality of destination network paths, transmitting the corresponding data unit to a next one of the respective plurality of network nodes along the one of the plurality of destination network paths.

### BRIEF DESCRIPTION OF THE DRAWINGS

Advantages of the subject matter described will become apparent to those skilled in the art upon reading this description in conjunction with the accompanying drawings, in which like reference numerals have been used to designate like or analogous elements, and in which:

FIG. 1 is a flow diagram illustrating a method for sending data units based on a measure of energy according to an aspect of the subject matter described herein;

FIG. 2 is block a diagram illustrating a system for sending data units based on a measure of energy according to another aspect of the subject matter described herein;

FIG. 3 is a block diagram illustrating an arrangement of components providing an exemplary environment for hosting the system for sending data units based on a measure of energy according to another aspect of the subject matter described herein; and

FIG. 4 is a block diagram illustrating an arrangement of network nodes communicatively coupled via a network.

### DETAILED DESCRIPTION

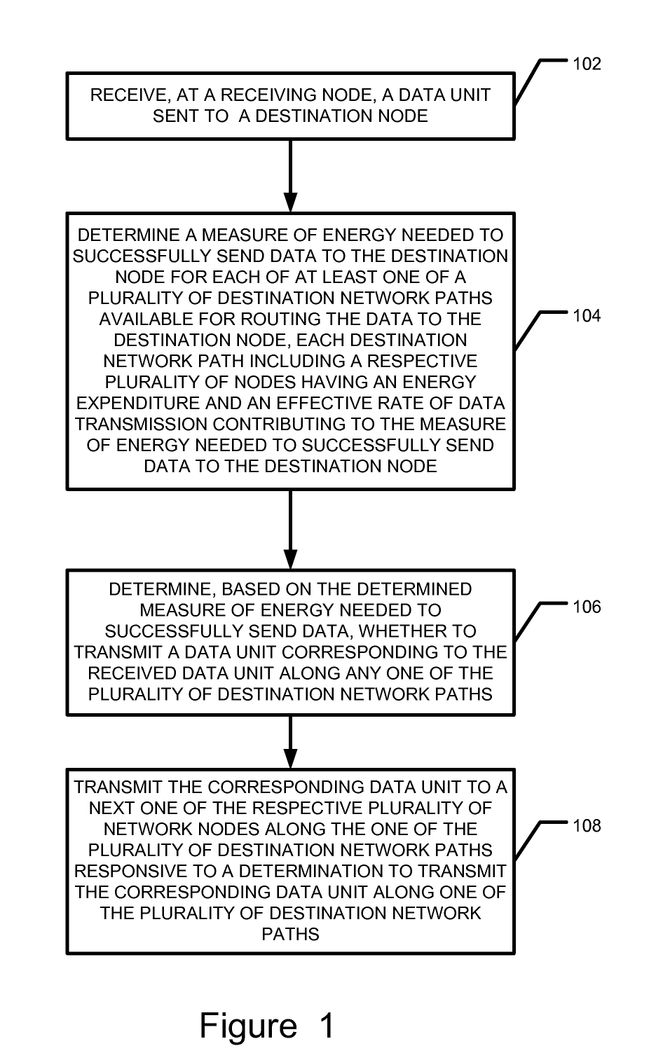

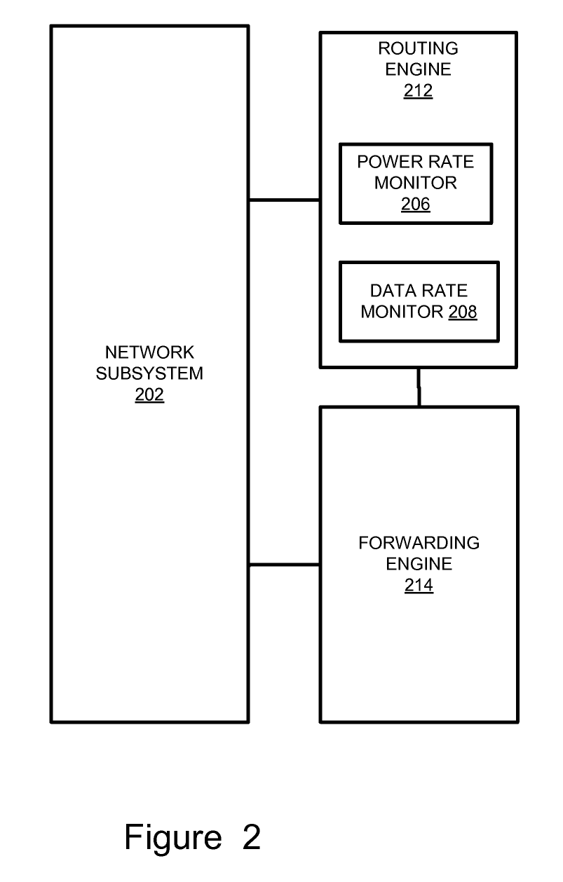

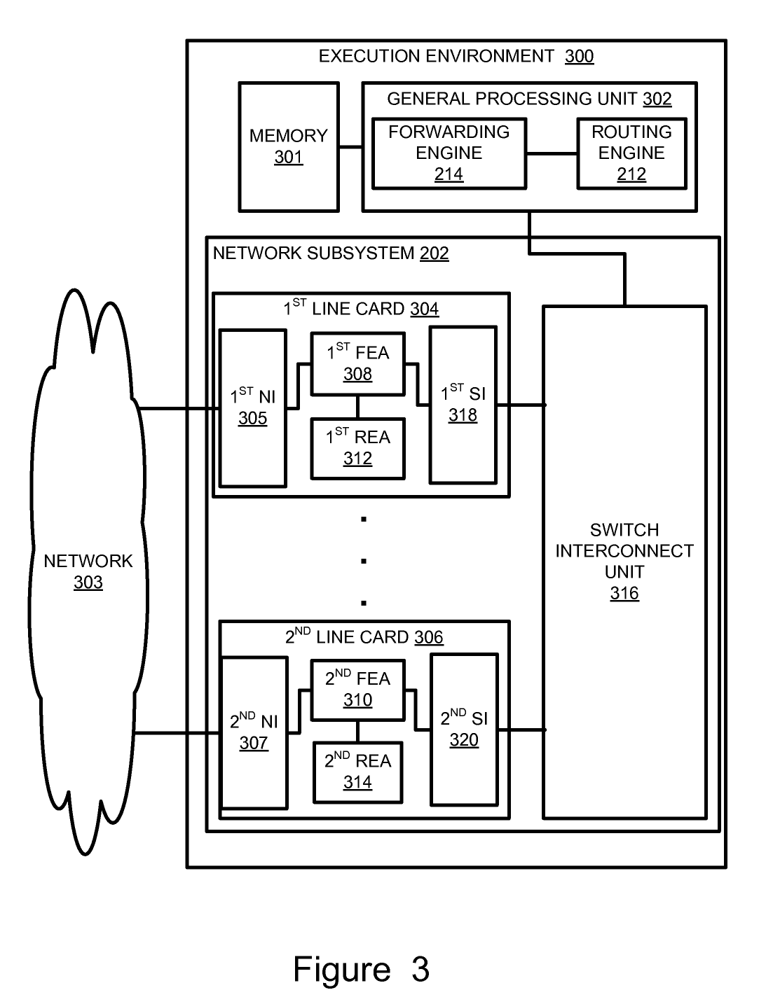

FIG. 1 is a flow diagram illustrating a method for sending data units based on a measure of energy according to an exemplary aspect of the subject matter described herein. FIG. 2 is a block diagram illustrating a system for sending data units based on a measure of energy according to another exemplary aspect of the subject matter described herein. FIG. 3 is a block diagram illustrating an arrangement of components providing an exemplary environment configured for hosting the system for sending data units based on a measure of energy according to another aspect of the subject matter described herein. The method illustrated in FIG. 1 can be carried out by, for example, some or all of the components illustrated in FIG. 2 or their analogs operating in an environment, such as the exemplary environment of. FIG. 3.

With reference to FIG. 1, in block 102, a data unit sent to a destination node is received via a network subsystem component at a receiving network node. Accordingly, a system for sending data units based on a measure of energy includes means for receiving, at a receiving network node, a data unit sent to a destination node. For example, as illustrated in FIG. 2, a network subsystem component 202 is configured to receive, at a receiving network node, a data unit sent to a destination node.

The receiving network node can be one of, for example, a router, a gateway, a switch, a virtual private network concentrator, a modem, a wireless access point, a bridge, a hub, a repeater, a firewall, a proxy server, an application for relaying data units, and the like. The receiving network node is not the final destination for the data unit. The execution environment 300 illustrated in FIG. 3 can be hosted fully by the receiving network node and/or can be hosted by multiple network nodes, as in a distributed execution environment, and is adapted for supporting the system components illustrated in FIG. 2. An exemplary execution environment 300 includes a memory 301 and a general processing unit 302, which can include a processor and/or a digital signal processor (DSP) for processing instructions and any data associated with the operation of the system components illustrated in FIG. 2. The components in FIG. 2, as well as functionally analogous arrangements of components, each can require additional hardware and/or software subsystems according to their particular operational requirements. For example, an operating system, persistent data storage subsystem, memory management subsystem, and/or a process scheduler are examples of additional components that can be used in FIG. 3 for hosting the system components in FIG. 2 and its functional analogs for performing the method in FIG. 1.

Returning to FIG. 1, in block 102 a data unit is received at a receiving network node via a network subsystem component 202. A data unit is, simply put, a unit of electronic data. One example of a data unit is a data packet, which is data segmented or packaged as a segment of data for transmission through a network. A data unit can be received and/or transmitted in a variety of forms. For example, a data unit can be received as a data packet. Additionally, several received data packets can be combined into a single data unit for transmitting, and a single data unit can be split into several packets for transmitting. For example, a single received data unit can be transmitted as two data packets as the data traverses a network path. The single received data unit and the two transmitted data packets are referred to as data or as a data unit herein. Also, a data unit formatted according to a first protocol can be converted to one or more data units formatted in a second protocol. Further, a data unit can be encapsulated in another data unit when received and the encapsulated data units can be transmitted unencapsulated, and vice versa. That is, received data units may differ from corresponding transmitted data units in some way or may be the same. A network node receiving the data unit will transmit a corresponding data unit (discussed further below) that is the same, substantially the same, or different in some ways, as discussed above.

As illustrated in FIGS. 2 and 3, the network subsystem component 202 is included in a receiving network node and operatively coupled to a network 303 for receiving and transmitting data. For example, the network subsystem component 202 can include one or more line cards 304, 306 and a switch interconnect unit 316. A line card 304 can be, for example, a network interface card (NIC) that transfers data units, such as packets, to an application for transmitting the data unit via a path in a network to a destination node. The NIC can be included in a desktop PC, a notebook, a server, or a handheld computing device serving as a gateway, bridge, or other network relay device. Further, the first line card 304 can also include more advanced functions for managing more data units as is described below. Alternatively, or in addition, network subsystem component 202 can include a network interface application program interface (API). SOCKETS is an exemplary network interface API. SOCKETS is an API configured for receiving a data unit transmitted to a destination node. Thus, a receiving network node can be a source node including a network interface API for receiving data for transmitting to a destination, and/or a receiving network node can be any intermediate node included in a path traversed by the data in one or more data units from the source node to a destination node.

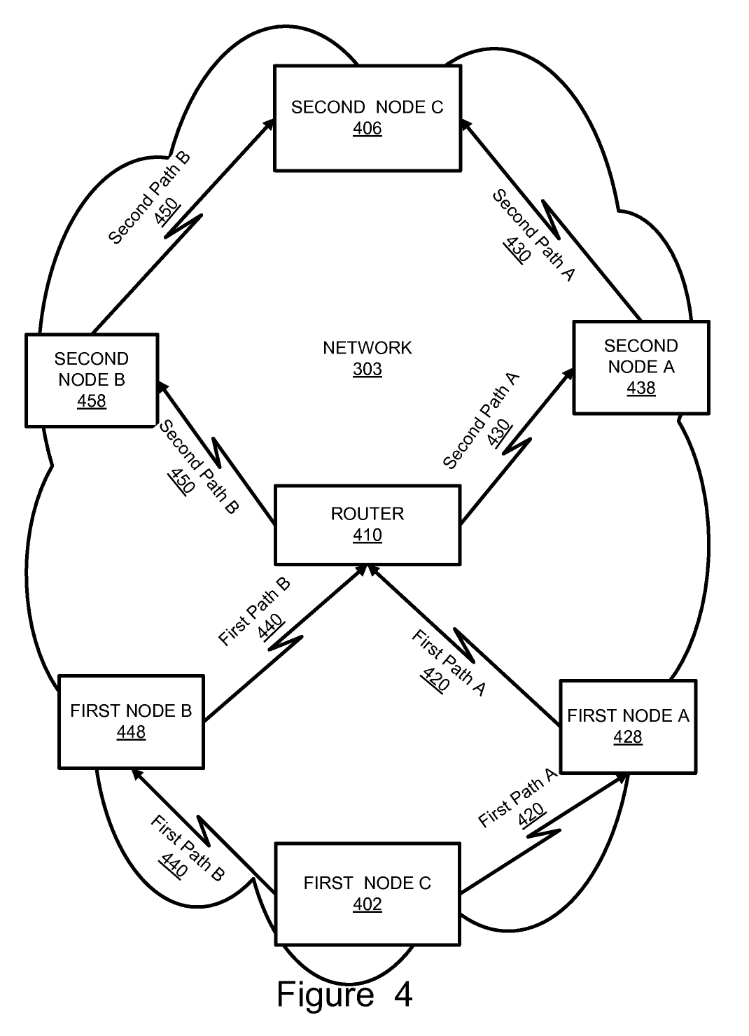

FIG. 4 is a block diagram illustrating an arrangement of network nodes communicatively coupled via a network. FIG. 4 depicts the exemplary network 303 operatively coupling and coupled to a number of network nodes configured to perform the role of a receiving network node. The first network subsystem component 202 can be operatively coupled to a portion of the network 303 that includes a source node, such as the first node C 402. The network subsystem component 202 can receive the data transmitted from the source node via a path included in the network 303. One or a plurality of paths can exist for transmitting the data unit. For example, the router 410 as the receiving network node can receive the data unit via a first path A 420 including a first node A 428. Alternatively or additionally, the data unit can be received via other paths and other network interfaces of the receiving network node when one exists between the receiving network node and the source node, such as alternative exemplary first path B 440 illustrated in FIG. 4. The first path B 440 includes a first node B 448 as a node in the path that the data unit can traverse from the first node C 402 to the router 410.

A receiving network node can be configured for receiving and for transmitting data units to a destination node at any protocol layer of the network 303. In an aspect, the data unit is one of a link layer data unit, a network layer data unit, an application layer data unit, a transport layer data unit, and a session layer data unit. For example, a receiving network node can receive and transmit a data unit at a link layer as performed by an Ethernet bridge and a multi-protocol labeling switch (MPLS). Further, a receiving network node can receive and transmit a data unit at a network layer as performed by an Internet protocol (IP) router. Further, a receiving network node can receive and transmit a data unit at a transport layer as performed by a proxy for relaying a unit from a first TCP connection to a second TCP connection. Further, a receiving network node can receive and transmit a data unit at a session layer as performed by a hypertext transmission protocol (HTTP) proxy for relaying HTTP message information associated with session information from a first HTTP message to a second HTTP message. Further, a receiving network node can receive and transmit a data unit at a presentation layer, an application layer, a physical layer as performed by a repeater, across protocol layers as performed by a protocol gateway, and across layers as performed by a protocol tunneling service.

Further, at each of the protocol layers, a variety of applications can host the arrangement illustrated in FIG. 2. For example, at the application layer, hosting applications can include a messaging application such as an email application and/or an instant messaging application; a subscription application such as a presence application; and a web application. As used herein, the term application can refer to a client application, a server application, a peer application, and distributed application components.

In one aspect, the received data unit identifies the destination node via at least a portion of one of an Internet protocol (IP) network address, a symbolic name corresponding to an IP address, and a media access control (MAC) address. For example, received data unit can be one or more data packets having a packet header including at least a portion of an IP network address, a symbolic name corresponding to an IP address, and/or a MAC address that identifies the destination node.

Returning to FIG. 1, in block 104 a measure of energy needed to successfully send data to the destination node is determined for each of at least one of a plurality of destination network paths available for routing the data to the destination node. Each destination network path includes a respective plurality of nodes having an energy expenditure and an effective rate of data transmission contributing to the measure of energy needed to successfully send data to the destination node. Accordingly, a system for sending data units based on a measure of energy includes means for determining a measure of energy needed to successfully send data to the destination node for each of at least one of a plurality of destination network paths available for routing the data to the destination node. For example, as illustrated in FIG. 2, a routing engine component 212 is configured to determine a measure of energy needed to successfully send data to the destination node for each of at least one of a plurality of destination network paths available for routing the data to the destination node.

As illustrated in FIG. 4, each destination network path includes multiple nodes having an energy expenditure and an effective rate of data transmission contributing to the measure of energy needed to successfully send data to the destination node. An effective rate of data transmission for a node can be associated with the rate of data successfully sent from a transmitter in a sending node, such as the first node C 402 illustrated in FIG. 4, along a path to a receiving network node. As described above, FIG. 4 illustrates the first path A 420 for transmitting data from the first node C 402 via the first node A 428 for receiving by a router 410. Each of the first node C 402, the first node A 428, and the router 410 can perform the role of a receiving network node. A second path A 430 is also illustrated, for transmitting data from the router 410 via a second node A 438 for receiving by the second node C 406. The first path A 420 combined with the second path A 430 illustrates one of a plurality of paths for transmitting data from the first node C 402 to the second node C 406. Each of the first node A 428, the router 410, the second node A 428, and the second node C 406 can perform the role of the destination node for a unit. FIG. 4, as described above, also illustrates the first path B 440 for transmitting data from the first node C 402 via a first node B 448 for receiving by the router 410 in the role of a receiving network node, a second path B 430, is also illustrated, for transmitting data from the router 410 via a second node B 458 for receiving by the second node C 406 in the role of a receiving network node.

In an aspect, a measure of energy is determined by determining at least one of a data throughput, a bit error rate (BER), a number of retries, a number of dropped units, and a number of collisions. For example, the routing engine component 212 is configured to determine a measure of energy by determining at least one of a data throughput, a bit error rate (BER), a number of retries, a number of dropped units, a number of collisions, and other such data rate variables known in the art. As illustrated in FIG. 2, the routing engine component 212 can include a data rate monitor 208 configured for compiling data rate information. The data rate information can be based on data transmission at any node along the path through network 303, such as through routers, links, or at other devices affecting communications through the network 303. The data rate can be based on a data transmission attribute of one or more of a link layer, a network layer, a transport layer, and/or any layer above the transport layer. The layers are, for example, those defined in the Open System Interconnection (OSI) Reference Model. For example, transmission control protocol (TCP) is a transport layer protocol, and Internet protocol (IP) is a network layer protocol included in the TCP/IP protocol suite.

In an aspect, determining a measure of energy includes measuring energy consumed associated with data transmission including energy consumption resulting from any unsuccessful data transmissions. For example, the routing engine component 212 is configured to determine a measure of energy by measuring energy consumed associated with data transmission including energy consumption resulting from any unsuccessful data transmissions. In an example, 1 Mb of data is transmitted by a NIC of the first node C 402 during a 1 s time period and only 500 Kb of data are received successfully by a receiving device, such as the router 410 or the second node C 406 due to dropped packets or other transmission errors. The data transmission rate for the given time period can be considered to be 500 Kb/s. The data transmission rate can be determined in whole or in part by feedback received from the receiving network node and/or another network node in a network path between the first node C 402 and the receiving network node. For example, the data rate monitor 208 of the routing engine component 212 can determine a data transmission rate associated with successfully sending data from a sending node a path, such as the first path A 420 for routing data from the first node C 402 to the router 410 via the first node A 428, and/or such as the second Path B 450 for routing data from the router 410 to the second node C 406 via the second node B 458.

In an aspect, the data rate monitor 208 determines a measure of data throughput for successful data transmission to a destination node by receiving data throughput feedback from the destination node via the network subsystem component 202. Alternatively, or in addition to receiving feedback from the destination node, the data rate monitor 208 can receive feedback from any node in the network 303 associated with sending at least a portion of the data transmitted by a node. For example, returning to the example of FIG. 4, where data is routed via the first path A 420 from the first node C 402 to the router 410 via the first node A 428, feedback can be received from any node in the network 303 associated with sending at least a portion of the data transmitted by a node, such as the router 410, the first node C 402, and/or the first node A 428. In yet another aspect, the data rate is determined by a combination of directly measuring throughput and any of the previously described techniques or by a combination of the previously described techniques. Note that a sending and/or a receiving network node can communicate using a wireless network interface and/or by using a wired network interface card (NIC), such as an Ethernet adapter.

The routing engine component 212 is configured to determine a measure of energy needed to successfully send data to the destination node for each of at least one of a plurality of destination network paths available for routing the data to the destination node. For example, the routing engine component 212 can include a power rate monitor 206 that determines a power rate associated with data transmission. The power rate will be higher at times that the network subsystem component 202 is not already in an active (transmitting) state because it will include the power needed to first activate or “wake up” the transmitter from an inactive state. In contrast, if the network subsystem component 202 is already sending other data, there is a lesser incremental power consumption increase resulting from sending the additional data. According to one aspect, the power rate monitor 206 determines a power rate based on whether the network interface 210 is in an active or inactive mode.

A measure of energy can be based on node information including energy expenditure information and node data rate information and/or their correlates. This node information is referred to as routing energy information in this document. Energy expenditure can be measured in terms of watts used, non-renewable resources consumed, emissions of one or more compounds in generating the expended energy, a measure of one or more waste products left from the generation of energy, monetary units, and the like.

According to an aspect, a consideration in determining a measure of energy can be the utility/supplier charge for power incurred. The power rate monitor 206 can determine a power rate based on utility charges for power. In another aspect, power rate monitor 206 can determine a power rate associated with data transmission by measuring a power rate of a network subsystem component 202 and any other components associated with the data transmission.

The routing engine component 212 determines the measure of energy needed to send data based on power cost information from the power rate monitor 206 and based on the determined data transmission rate measure from data rate monitor 208. For example, routing engine component 212 can determine a measure of energy by dividing the power rate by the data transmission rate measure or by using another calculation method or algorithm.

A measure of energy for sending data via the network interface 210 can be combined with routing energy information from other nodes along a path to the destination node. Routing energy information can be received via a user interface, a configuration data store, and/or via a message received from another node. In an aspect, determining a measure of energy includes implementing or modifying at least one of a data routing policy, a data routing table, and a data routing decision based on the received routing energy information. For example, the routing engine component 212 can be configured to determine a measure of energy by implementing or modifying at least one of a data routing policy, a data routing table, and a data routing decision based on the received routing energy information. The routing energy information can be used for specifying a routing policy, evaluating a routing policy, and/or for generating and maintaining a routing table.

In one aspect, the routing engine component 212 can be configured to determine a measure of energy by receiving routing energy information in a message. The message can be received according to a routing protocol. For example, routing energy information can be received in a message, such as a message from a directory service such as a domain name service (DNS). For example, the receiving network node's routing engine component 212 can send a query to the DNS system for retrieving geospatial information associated with a network address of a node stored in a LOC record. The node can be included in a path to a destination node. Routing energy information can be determined based on geospatial information received in a response from the DNS system to the query. The cost of power can vary across geospatial regions. Available bandwidth, congestion, reliability, and network outages can vary across geospatial regions as well.

The routing engine component 212 can also be configured to determine a measure of energy by receiving routing energy information with the received data unit. The message including routing energy information can be and/or can include the data unit. For example, the data unit can include routing energy information associated with identified network addresses of a portion of a path from the node receiving the message node to a potential destination node, such as a route traversed and/or a route allowing the data unit to be transmitted to a potential destination node. In an example, an IP packet routed using source routing can include routing information including routing energy information. Further, routing energy information can identify a network interface of a node included in the portion of the path. Data rate and/or routing energy information can be associated with the network subsystem component 202. The information can be included in, for example, an IP packet, a message including routing information, and/or can be queried from a data store configured to receive, store, and provide data rate and/or routing energy information allowing nodes in a network to exchange the information.

Routing energy information can include a measure of energy expenditure and effective data rate and/or can include information for determining one or more measures. For example, the routing energy information included in the received data unit can include an energy expenditure and effective data rate as a measure of watts expended per data unit successfully sent. Alternatively or additionally, routing energy information can include a measure of dollar cost of energy per megabyte of data successfully transmitted along a path to another node or over a link to a next node. For example, energy expenditure and effective data rate information can be included in an energy expenditure index that can be numeric or non-numeric. Effective data rate can be represented in an analogous representation and identified with a node in a portion of a path to a potential destination node. The energy information can be from and/or certified by a third-party.

In another aspect, the routing engine component 212 can be configured for managing one or more routing policies and/or configured for managing one or more routing tables. A routing table can be generated and updated based on one or more metrics associated with routes in a network. Examples of metrics currently in use include path length, bandwidth, delay, and reliability, such as a metric based on dropped packets. A metric can consist of any value that can be used to determine whether a route in a network should perform better than another route in the network. For example, a routing algorithm can use the metric in determining whether a route in a network should perform better than another route in the network. An energy expenditure and effective node data rate information can be expressed as an energy metric expressing a measure of energy needed to successfully send data to a next node in a path to a destination node. Routing energy information can include an energy metric and/or information for determining an energy metric. The path energy metrics expressing a measure of energy needed to successfully send data to a destination node along a path including a plurality of nodes can be based on a plurality of energy metrics corresponding to at least a portion of the plurality of nodes in the path.

A number of routing protocols can be modified and/or extended to provide an energy metric indicating an energy expenditure and effective data rate information associated with a portion of a path to the destination node. A portion of the path can include the entire path from the source node to the destination node or any portion of that path. The portion of the path can be a single node, multiple nodes, a cable connecting two nodes, or any combination thereof. Accordingly, routing energy information and/or path routing energy information can be associated with a portion of a path without there being a node directly coupled to the portion of the path. Alternatively, the portion of the path can include a single node.

Similarly, routing energy information associated with a portion of a path for routing policy specification and/or evaluation can be received via a message from any node in the network 303. Various protocols can be modified and/or extended to provide routing energy information for routing policy evaluation and/or an energy metric for generating and updating a routing table. In an aspect, the routing protocol includes at least one of a link-state protocol, a distance vector protocol, a path vector protocol, and a label switching protocol. For example, link state protocols such as the Open Shortest Path First (OSPF), distance vector protocols such as the Routing Information Protocol (RIP), path vector protocols such as the Border Gateway Protocol (BGP), and label switching protocols such as Multi-protocol Label Switching (MPLS) can be extended and/or modified. Both OSPF and RIP message formats support a message area for one or more metrics. A metric representing a measure of energy needed for routing data along at least a portion of destination path to a destination node can be associated with a node, such as a router, and can be included along with other optional metrics. Alternatively or additionally an analogous metric can be associated with at least a portion of a path. The exchange of routing energy information associated with a node and/or a path can be included in a determination by the routing engine component 212 of a measure of energy needed to transmit data along a destination path including the associated node or path to a destination node. A node can send messages according to BGP to advertise destination paths to reach a destination. A receiving network node, receiving such information, can apply one or more policies associated with one or more nodes included in the portion of the destination path. The advertised path information can include routing energy information and/or the routing energy information can be received along with the advertised path information.

A routing policy can take routing energy information received by the node as described above as input for evaluating the routing policy. Further, a routing policy can take geospatial information and/or other information associated with a node in a path for identifying an energy expenditure and effective data rate information as a result of evaluating the routing policy. For example, the routing can also be based on the size of a data unit, the protocol of a packet payload of a data unit, or some other characteristic. It can also be based on a combination of characteristics. In MPLS, labels (and thus routes) are determined by a data units' forwarding equivalence class (FEC). A FEC can be defined based on an energy expenditure and effective data rate information associated with a node in a path to a destination. The energy expenditure and effective data rate information can be associated with a geospatial region associated with the node and identified by geospatial information.

The routing policy can be selected based on one or more data transmission-related characteristics. Some or all of the data transmission-related characteristics can be determined by monitoring device processes. For example, the type of data being transmitted, a type of transmission, a data size being transmitted, a type of application requesting the transmission, a destination of the data transmission, a time of day, a location of the sending device, previous data transmissions, and a priority associated with the type of data being transmitted can be determined by monitoring applications. In one example, an e-mail being sent to a spouse can be given higher priority than an e-mail sent to someone else, as can be dictated by the corresponding routing policy. Emails, in general, can be assigned to one routing policy while instant messages and photographs are assigned to other routing policies.

Returning to FIG. 4, the data unit can be transmitted by the first node C 402 and associated with a portion of a path that can be a first path traversed by the data unit and/or a second path allowing the data unit to be transmitted to the destination node from the receiving network node. The destination node is considered to be included in the path. For example, the data unit is associated with a first path A 420 including the first node A 428 when the data unit traverses the first path A 420 to the receiving router 410, for receiving by the network subsystem component 202. With respect to the second path, the data unit is associated with a second path A 430 including a second node A 438 in that the data unit can traverse the second path A 430 from the router 410 to the second node C 406. Any portion of a second path actually traversed from the receiving router 410 to the second node C 406 is a destination path.

The routing engine component 212 can be configured for receiving routing energy information for determining an energy metric associated with the first node A 428 and/or the second node A 438 when the unit is received via the first path A 420. When the data unit traverses the first path A 420, the routing engine component 212 is configured for identifying a measure of energy associated with one or more network nodes in the first path A 420 such as the first node A 428. Alternatively or additionally, when it is determined that the data unit can reach the router 410 by traversing the second path A 440, the routing engine component 212 can determine an energy metric associated with one or more nodes in the second path A 440, such as the second node A 448. In the network 303, an additional path to the second node C 406 is illustrated as the second path B 450 including a second node B 458. The routing engine component 212 can receive routing energy information including and/or for determining an energy metric associated with the second node B 458. Routing energy information identifying and/or for determining an energy metric can be received via a configuration interface and/or via a message from one or more nodes in the network 303 including the receiving network node including the routing engine component 212.

Energy expenditure and effective data rate information can be determined based on a distance between a node included in a portion of the path and a next node in the path. The energy expenditure and effective data rate information can vary inversely with the distance, so that a node is more efficient as the distance is shorter, and vice versa. Routing energy information can be based on a relationship between owners of at least a portion of a path and/or a node in a path. For example, a high energy metric can be associated with at least a portion of a path and/or a node in the path with a common owner known to have older networking equipment. An administrative entity for administering a node, and/or at least a portion of a path, can identify or be used for determining an energy metric based on an energy certification granted to the administrative energy, analogous to an energy star rating for an electronic device. An energy metric and/or other representation of a measure of energy needed to transmit data along a particular path to a destination can be assigned to a node in the particular path and/or to at least a portion of the particular path.

A measure of energy can be associated with at least a portion of a path based on a past event or lack of a past event. For example, a lower measure of energy can be associated with a portion of a path known to have a relatively lower energy expenditure and/or effective data rate than another path without any known current or past history of energy usage and/or data rate information.

Further a measure of energy can be associated with portion of a path based on an agreement made by an entity associated with the node and the region. For example, as described above, a government entity with control over at least a portion of path can be a signatory to an agreement for ensuring the at least a portion of the path meets a specified energy usage requirement where energy expenditure is associated with effective data rates. An agreement can be a contract and/or an informal agreement between entities associated with at least a portion of a path and/or a node in the path. Further, a measure of energy can be associated with a quality of service (QOS) provided by a portion of a network. The provider can charge prices based on energy expenditure and effective data rate usage. An energy metric associated with at least a portion of a path and/or a node in a path can vary with time. For example, a subnet including the second node B 458 can have a higher energy metric at certain hours of the day or certain times of the year.

A receiving network node can update a measure of energy associated with a node in a path and/or at least a portion of the path maintained for it based on a measure of energy associated with another node and/or at least a portion of another path in the network 303. The receiving network node can send a message to another node in the network 303 to alter an energy metric associated with the other node. Still further, the receiving network node can send a message to a node to alter the energy expenditure and effective data rate information the node associates with still another node in the network 303. The updates/alterations can be based on interaction of the receiving network node with other nodes in the network 303 and/or can be based on user provided data.

Energy expenditure and effective data rate information associated with a node can be determined and/or modified based on the data units a receiving network node accepts and/or transmits, the paths traversed by the accepted data units, and traversed by the transmitted units.

Returning to FIG. 1, in block 106, whether to transmit a data unit corresponding to the received data unit along any one of the plurality of destination network paths is determined based on the determined measure of energy needed to successfully send data. Accordingly, a system for sending data units based on a measure of energy includes means for determining, based on the determined measure of energy needed to successfully send data, whether to transmit a data unit corresponding to the received data unit along any one of the plurality of destination network paths. For example, as illustrated in FIG. 2, a forwarding engine component 214 is configured to determine, based on the determined measure of energy needed to successfully send data, whether to transmit a data unit corresponding to the received data unit along any one of the plurality of destination network paths.

The forwarding engine component 214 can be configured for evaluating a routing policy and/or a routing table to determine whether to transmit a data unit corresponding to the received data unit along any one of the plurality of destination network paths. In an aspect, a routing table operation is performed on a routing table based on the determined measure of energy. For example, the forwarding engine component 214 can be configured for performing a routing table operation on a routing table based on the measure of energy determination made by the routing engine component 212. A routing table operation can include a routing table lookup. Further, a routing table operation can include any operation for maintaining the routing table, such as updating the routing table. In one example, the structure of the routing table and/or an associated lookup operation can be based on an energy metric based on energy expenditure and effective data rate information. In such an aspect, the measure of energy can be expressed in a metric. Both the routing policy and the routing table can include and/or generate routing information.

In another aspect, determine whether to transmit a data unit corresponding to the received data unit along any one of the plurality of destination network paths includes performing a routing policy operation on a routing policy based on the determined measure of energy. For example, the forwarding engine component 214 can be configured for performing a routing policy operation on a routing policy based on the measure of energy determination made by the routing engine component 212. A routing policy operation can include an evaluation of the routing policy. A routing policy can be specified including a measure of energy as a variable or a condition based on an energy metric. As discussed above, a routing policy can be evaluated based on a measure of energy received as input for the routing policy evaluation. Alternatively or additionally, a routing policy can generate an energy metric based on energy expenditure and effective data rate information as a result of evaluating the routing policy. Further, a routing policy can generate routing information including a subnet identifier, a label, and/or a network interface address of a node in a path. A routing table including routing information can be generated and/or maintained based on a metric expressing a measure of energy based on energy expenditure and effective data rate information. A lookup to the routing table can return routing information including a path specification, a subnet identifier, a network and/or address of next hop node.

Accordingly, the forwarding engine component 214 can be configured to transmit the data to a next one of the respective plurality of network nodes along the one of the plurality of destination network paths by identifying at least a portion of a network address associated with a next hop in the one of the plurality of destination network paths based on the measure of energy determination and identifying the network interface based on the identified at least a portion of the network address.

When data is received via a network subsystem component 202 of a receiving network node, the network subsystem component 202 can provide data unit information, such as the network address of the destination node, to the forwarding engine component 214. The forwarding engine component 214 can receive the routing information from the measure of energy determination provided by the routing engine component 212. The forwarding engine component 214 can be configured to identify a line card 304,306 and/or network interface 305, 307, such as the second line card 306 and/or the second network interface 307, to transmit the data unit via a destination path to the destination node based on the routing information and network information associated with each line card and/or network interface. Alternatively, the forwarding engine component 214 can be configured to identify a transmitter, a wireless communication channel, path, or protocol, or another communication means. The term destination path is used herein to represent the various alternatives for selecting communication paths to a destination. Further, the forwarding engine component 214 can be configured to indicate that no destination path is acceptable at this time, i.e., identify no communication path, in favor instead of delaying data transmission and/or discarding the data unit.

According to an aspect, identifying the destination path includes performing a routing policy operation on a routing policy based on the determined measure of energy needed to transmit the data over the destination path. The determined measure of energy is based on energy expenditure and effective data rate information associated with at least a portion of the path such as a node in the destination path. For example, the forwarding engine component 214 can be configured for performing a routing policy operation on a routing policy based on a determined energy metric to identify the destination path. As discussed above, the routing policy operation on a routing policy can include an evaluation of the routing policy. As such, the forwarding engine component 214 can be configured for determining the destination path for transmitting the data unit based on an evaluation of a routing policy based on a node and/or path energy expenditure and effective data rate information. The forwarding engine component 214 can retrieve a routing policy from the routing engine component 212 for evaluation. The routing policy can be retrieved based on any information in the data unit, a path associated with the data unit, a node included in the destination path associated with the data unit, geospatial information, an energy expenditure and effective data rate information indicator, and other data as required for operation of the network 303 and or the receiving network node.

The routing policy is evaluated based on energy expenditure and effective data rate information as described above. Routing energy information for identifying a measure of energy can be from another node in the network 303 and/or received via user configuration as described above. Also as describe above, routing energy information can be included in and/or along with the data unit information. The forwarding engine component 214 can evaluate the routing policy based on the measure of energy determined based on the received energy expenditure and effective data rate information. Alternatively, the routing engine component 212 can evaluate the routing policy based on the data unit information provided by the forwarding engine component 214.

In another aspect, determining the destination path can include performing a routing table operation on a routing table based on the determined energy metric. For example, the forwarding engine component 214 can be configured to perform a routing table operation on a routing table based on the determined energy metric to identify the destination path. As discussed above, a routing table operation on a routing table can include a routing table lookup. The forwarding engine component 214 can be configured to determine a destination path for transmitting the data unit over one of a plurality of paths to the destination node by performing a lookup operation on a lookup table. For example, the forwarding engine component 214 can provide data unit information such as the network address of the router 410 to the routing engine component 212 to perform a lookup in a routing table maintained by the routing engine component 212. The routing table structure and/or the lookup operation can be based on the energy metric determined as described above. The lookup results can be returned to the forwarding engine component 214.

Based on the results of the routing policy evaluation and/or the results of the lookup operation, the forwarding engine component 214 can be configured to determine a destination path of the receiving network node for transmitting the data unit. In an aspect, determining whether to transmit a data unit corresponding to the received data unit includes comparing the determined measure of energy to a threshold amount and determining whether to transmit a data unit corresponding to the received data unit along any one of the plurality of destination network paths based on the comparison. For example, the forwarding engine component 214 can be configured to determine whether to transmit a data unit corresponding to the received data unit by comparing the determined measure of energy to a threshold amount and determining whether to transmit a data unit corresponding to the received data unit along any one of the plurality of destination network paths based on the comparison. For example, the forwarding engine component 214 can be configured for evaluating a threshold condition based on the energy metric associated with the at least a portion of the path and for identifying the destination path in response to evaluating the threshold condition.

The forwarding engine component 214 can, in response to evaluating the routing policy, determine whether the threshold is met. When the determination indicates the threshold is met, the forwarding engine component 214 can determine the destination path for transmitting the data unit. The forwarding engine component 214 can identify a network address of a next hop node in the path to the destination node as a result of the routing policy evaluation. The address of the next hop node can include a subnet identifier that can be compared to a subnet identifier provided by a line card 304,306 including a network interface 305,307. A match of the subnet identifiers identifies, in this example, the line card 304,306 and/or network interface 305,307 and consequently the destination path for transmitting the data unit to the identified destination node.

Alternatively or additionally, the node can be a node in a path traversed by the data unit, such as the first network node A 426. The forwarding engine component 214 can, in response to evaluating the routing policy, determine whether the threshold is met. For example, the routing policy can include a measure of power already used in transmitting data partially through a network towards an identified destination node. When the determination indicates the threshold is met, the forwarding engine component 214 can determine a destination path for transmitting the data unit. The forwarding engine component 214 can determine a network address of a node in the determined path as a result of the routing policy evaluation. The address of the node can include a subnet identifier that can be compared to a subnet identifier provided by a line card including a network interface. A match of the subnet identifiers can identify the line card and thus the destination path.

In the network 303 illustrated in FIG. 4, the second node A 438 can be the next node for receiving the data unit over the determined destination path. Alternatively, the second node A 438 can be a node in a path to the determined node from the next node to the second node C 406 identified as the destination node. In either case, the exemplary second node A 438, as well as each node in the second path A 430, is associated with the data unit when the data unit is to be routed over the second path 430 to the second node C 406 as the destination node.

As discussed above, more than one path can exist in a network for transmitting a data unit to a destination node. A receiving network node can include one or more line cards 304, 306 having network interfaces 305, 307 each for transmitting a data unit via one or more of a plurality of destination paths. The forwarding engine component 214 can be configured for identifying a line card for transmitting the data unit via an optimal path according to a determined measure of energy associated with at least one of the one or more paths. Optimal can be defined by a routing policy evaluated and/or a lookup operation on a particular routing table.

According to an aspect illustrated in FIG. 3, the network subsystem component 202 even more optional components for enhancing its operation. In the exemplary network subsystem component 202, a first network interface 305 is illustrated included in a first line card 304, and the second network interface 307 is illustrated included in a second line card 306. Each line card 304, 306 can include a respective routing engine component agent (REA) 312, 314. An REA can be provided for distributing the operation of the routing engine component 212, offloading the work of the routing engine component 212, and reducing traffic flow between the line cards 304, 306 and the routing engine component 212. An REA can operate as a cache storing a portion of the routing table maintained by the routing engine component 212 and performing lookups locally in the respective line card 304, 306.

As discussed above, the routing table operation can include an operation that updates the routing table based on an energy metric associated with a node and/or at least a portion of a path. The routing information included in and provided by the routing table is based on a node and/or path energy expenditure and effective data rate information for updating the routing table. Routing energy information for determining an energy metric can be user provided and/or can be provided by another node as described above. The updating operation can be performed by the routing engine component 212. The type of update operation performed on the routing table depends on the routing protocol(s) supported by the receiving network node. The update operation can be performed in accordance with at least one of a link-state protocol, a distance vector protocol, a path vector protocol, and a label switching protocol. In a link-state protocol, an energy metric associated with a node in a next hop in a path can be provided. For example, an energy metric can be included in a type of service (TOS) field provided in a link-state advertisement (LSA) supported by the OSPF protocol. In a distance-vector routing protocol, an energy metric and/or energy expenditure and effective data rate information for determining an energy metric can be provided as a “distance” metric. For example, an energy metric can be included in a metric field supported by the RIP protocol (the metric field in RIP messages is currently used to specify a hop count). In a path vector protocol, an energy metric can be provided as a metric associated with a path to a node. The BGP protocol supports primarily policy-based routing discussed above, but can be extended to include a field for transmitting and receiving energy expenditure and effective data rate information and/or an energy metric as can other protocols for supported policy-based routing.

FIG. 3 also illustrates each line card 304, 306 of the receiving network node including a respective forwarding engine component agent (FEA) 308, 310. An FEA 308, 310 can be configured to interoperate with an associated REA 312, 314 as the forwarding engine component 214 interoperates with the routing engine component 212 to determine a network interface of a path to a destination node for transmitting a data unit. An FEA 308, 310 provides distributed operation of the forwarding engine component 214 by offloading the work of the forwarding engine component 214 and reducing traffic flow between the line cards and the forwarding engine component 214. An FEA 308, 310 can operate, as indicated above, with an REA for evaluating a routing policy and/or performing a routing table lookup in a line card of a received data unit. If a network interface 305, 307 for transmitting the data unit is identified, the FEA and REA can interoperate with the forwarding engine component 214 and routing engine component 212, respectively, to improve efficiency.

Returning to FIG. 1, in block 108 the corresponding data unit is transmitted to a next one of the respective plurality of network nodes along the one of the plurality of destination network paths responsive to a determination to transmit the corresponding data unit along one of the plurality of destination network paths. Accordingly, a system for sending data units based on a measure of energy includes means for transmitting the corresponding data unit to a next one of the respective plurality of network nodes along the one of the plurality of destination network paths responsive to a determination to transmit the corresponding data unit along one of the plurality of destination network paths. For example, as illustrated in FIG. 2, the network subsystem component 202 is configured to transmit the corresponding data unit to a next one of the respective plurality of network nodes along the one of the plurality of destination network paths responsive to a determination to transmit the corresponding data unit along one of the plurality of destination network paths.

With reference to FIGS. 2 and 3, the forwarding engine component 214 can instruct the network subsystem component 202 to transmit the data unit along the destination path, for example by selecting one of the plurality of line multiple line cards 304, 306 available in the network subsystem 200. In one example, the data unit can be routed into network 303 via the second network interface 307 of the second line card 306 as opposed to the first network interface 305 of the first line card 304. Selection of the line card and/or network interface or routing the data unit can be realized by connecting the data unit to the line card and/or network interface through an appropriate connection medium, such as the switch interconnect unit 316 illustrated in FIG. 3, or through a bus or other connection medium. Alternatively, as discussed above, the forwarding engine component 214 can be configured to identify a transmitter, a wireless communication channel, path, or protocol, or another communication means, or to indicate that no destination path is acceptable at this time, i.e., identify no communication path, in favor instead of delaying data transmission and/or discarding the data unit.

In the example of FIG. 3, the forwarding engine component 214 can configure the switch interconnect unit 316 to provide a communication channel from the first line card 304, via which a data unit was received, to the second line card 306, via which a corresponding data unit will be transmitted. It should be pointed out that the transmitted corresponding data unit can be a new data unit or the same, or substantially the same, data unit that was received. Each line card 304, 306 can include a respective switch interface (SI) 318, 320 each operatively coupled to the switch interconnect unit 316 and configured for writing data to a channel configured in the switch interconnect unit 316 and/or for reading data from a configured channel. An FEA 308, 310, such as the first FEA 308, can assist the forwarding engine component 214 in identifying the network interface 305, 307, in this case the second network interface 307, for transmitting the data unit. A first SI 318 of the first line card 304 can setup a channel for communicating the data unit to the second SI 320 of the second line card 306. The second SI 320 can read the data and provide the data to the identified second network interface 307 for transmitting. An FEA 308, 310 optionally interoperating with an associated REA 312, 314 can be configured for working in conjunction with the forwarding engine component 214 and the routing engine component 212, respectively, for modifying the transmission of the data unit based on a routing policy and/or routing table information stored in the including line card 304, 306, as discussed above. For example, the second FEA 310 interoperating with the second REA 314 can alter a path including a next hop to be traversed by the data unit prior to providing the data unit to the second network interface 307 for transmitting. The second FEA 310 can help identify yet another network interface 305, 307 for transmitting the data unit or can interoperate with the forwarding engine component 214 to identify another network interface 305, 307 or confirm the selection of the second network interface 307 by the first FEA 308.

The data unit can have a data unit type, such as a unicast data unit, broadcast data unit, and multicast data unit associated with one or more destination nodes. Accordingly, multiple line cards and/or network interfaces can be identified for transmitting the data unit via one or more destination paths to one or more destination nodes, if appropriate.

In another aspect, transmitting the data unit includes discarding the data unit. For example, the forwarding engine component 214 can be configured to discard the corresponding data unit, for example, by providing it to a line card with a null network interface.

In another aspect, transmitting the data to a next one of the respective plurality of network nodes along the one of the plurality of destination network paths includes associating the corresponding data unit with a priority based on the measure of energy and determining a position in a transmission queue associated with the one of the plurality of destination network paths based on the associated priority. For example, the forwarding engine component 214 can be configured to transmit the data to a next one of the respective plurality of network nodes along the one of the plurality of destination network paths by associating the corresponding data unit with a priority based on the measure of energy and determining a position in a transmission queue associated with the one of the plurality of destination network paths based on the associated priority. In the example given by FIG. 3, a network interface 305, 307 can have one or more queues for queuing data units for transmitting in an orderly fashion. A priority can be associated with a data unit for determining a queue and/or a position in a queue for placing the data unit for transmitting by the network interface 305, 307 along the destination path. The forwarding engine component 214 can assign a priority to a data unit based on the measure of energy needed to transmit the data along the destination path associated with the network interface 305, 307.

For example, when the determined measure of energy is relatively low, the forwarding engine component 214 can apply a routing policy that assigns a relatively high priority to the data unit, thus “rewarding” paths having associated low measures of energy. Alternatively, when the determined measure of energy is relatively high, the forwarding engine component 214 can apply a routing policy that assigns a relatively low priority to the data unit.

In another aspect, identifying the destination path includes configuring a communication channel for transmitting the data unit from a received storage location along the one of the plurality of destination network paths. For example, the forwarding engine component 214 can be configured to configure a communication channel for transmitting the data unit from the memory 301 along the one of the plurality of destination network paths.

It should be understood that the various system components (and means) defined by the claims and illustrated in the various block diagrams represent logical components that are configured to perform the functionality described herein. While at least one of these components are implemented at least partially as or with an electronic hardware component, and therefore constitutes a machine, the other components may be implemented in software, hardware, or a combination of the two. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of the two. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

Moreover, the methods described herein can be embodied in executable instructions stored in a computer readable medium for use by or in connection with an instruction execution machine, apparatus, or device, such as a computer-based or processor-containing machine, apparatus, or device. As used here, a “computer-readable medium” can include one or more of any suitable media for storing the executable instructions of a computer program in one or more of an electronic, magnetic, optical, and electromagnetic, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-Ray™ disc; and the like.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for sending data units based on a measure of energy, the method comprising:
receiving, at a receiving network node, a data unit sent to a destination node;
determining a measure of energy needed to successfully send data to the destination node for each of at least one of a plurality of destination network paths available for routing the data to the destination node, each destination network path including a respective plurality of nodes having an energy expenditure and an effective rate of data transmission contributing to the measure of energy needed to successfully send data to the destination node;
determining, based on the determined measure of energy needed to successfully send data, whether to transmit a data unit corresponding to the received data unit along any one of the plurality of destination network paths; and
responsive to a determination to transmit the corresponding data unit along one of the plurality of destination network paths, transmitting the corresponding data unit to a next one of the respective plurality of network nodes along the one of the plurality of destination network paths,
wherein at least one of the preceding actions is performed on at least one electronic hardware component.

2. The method of claim 1 wherein the receiving network node is one of a router, a gateway, a switch, a virtual private network concentrator, a modem, a wireless access point, a bridge, a hub, a repeater, a firewall, a proxy server, and an application for relaying data units.

3. The method of claim 1 wherein the corresponding data unit is the received data unit.

4. The method of claim 1 wherein the corresponding data unit is one of a link layer data unit, a network layer data unit, an application layer data unit, a transport layer data unit, and a session layer data unit.

5. The method of claim 1 wherein the received data unit identifies a destination node via at least a portion of one of an Internet protocol (IP) network address, a symbolic name corresponding to an IP address, and a media access control (MAC) address.

6. The method of claim 1 wherein determining a measure of energy includes determining at least one of a data throughput, a bit error rate (BER), a number of retries, a number of dropped packets, and a number of collisions.

7. The method of claim 1 wherein determining a measure of energy includes measuring energy consumed associated with data transmission including energy consumption resulting from any unsuccessful data transmissions.

8. The method of claim 1 wherein determining a measure of energy includes receiving routing energy information from another network node.

9. The method of claim 8 wherein determining a measure of energy includes implementing or modifying at least one of a data routing policy, a data routing table, and a data routing decision based on the received routing energy information.

10. The method of claim 1 wherein determining a measure of energy includes receiving routing energy information with the received data unit.

11. The method of claim 1 wherein determining a measure of energy includes receiving routing energy information in a message received according to a routing protocol.

12. The method of claim 11 wherein the routing protocol includes at least one of a link-state protocol, a distance vector protocol, a path vector protocol, and a label switching protocol.

13. The method of claim 1 wherein determining whether to transmit a data unit corresponding to the received data unit includes comparing the determined measure of energy to a threshold amount and determining whether to transmit a data unit corresponding to the received data unit along any one of the plurality of destination network paths based on the comparison.

14. The method of claim 1 wherein transmitting the data to a next one of the respective plurality of network nodes along the one of the plurality of destination network paths includes:
identifying at least a portion of a network address associated with a next hop in the one of the plurality of destination network paths based on the measure of energy determination; and
identifying the one of the plurality of destination network paths based on the identified at least a portion of the network address.

15. The method of claim 14 wherein identifying the one of the plurality of destination network paths further comprises configuring a communication channel for transmitting the data unit from a received storage location along the one of the plurality of destination network paths.

16. The method of claim 1 wherein determining whether to transmit a data unit corresponding to the received data unit includes discarding the corresponding data unit.

17. The method of claim 1 wherein the corresponding data unit is at least one of unicast data unit, a multicast data unit, and a broadcast data unit.

18. The method of claim 14 wherein transmitting the data to a next one of the respective plurality of network nodes along the one of the plurality of destination network paths includes:
associating the corresponding data unit with a priority based on the measure of energy; and
determining a position in a transmission queue associated with the one of the plurality of destination network paths based on the associated priority.

19. System for sending data units based on a measure of energy, the system comprising:
means for receiving, at a receiving network node, a data unit sent to a destination node;
means for determining a measure of energy needed to successfully send data to the destination node for each of at least one of a plurality of destination network paths available for routing the data to the destination node, each destination network path including a respective plurality of nodes having an energy expenditure and an effective rate of data transmission contributing to the measure of energy needed to successfully send data to the destination node;
means for determining, based on the determined measure of energy needed to successfully send data, whether to transmit a data unit corresponding to the received data unit along any one of the plurality of destination network paths; and
means for, responsive to a determination to transmit the corresponding data unit along one of the plurality of destination network paths, transmitting the corresponding data unit to a next one of the respective plurality of network nodes along the one of the plurality of destination network paths,
wherein at least one of the means includes at least one electronic hardware component.

20. A system for sending data units based on a measure of energy, the system comprising system components including:
a network subsystem component configured to receive, at a receiving network node, a data unit sent to a destination node;
a routing engine component configured to determine a measure of energy needed to successfully send data to the destination node for each of at least one of a plurality of destination network paths available for routing the data to the destination node, each destination network path including a respective plurality of nodes having an energy expenditure and an effective rate of data transmission contributing to the measure of energy needed to successfully send data to the destination node;
a forwarding engine component configured to determine, based on the determined measure of energy needed to successfully send data, whether to transmit a data unit corresponding to the received data unit along any one of the plurality of destination network paths; and
the network subsystem component configured to, responsive to a determination to transmit the corresponding data unit along one of the plurality of destination network paths, transmit the corresponding data unit to a next one of the respective plurality of network nodes along the one of the plurality of destination network paths,
wherein at least one of the system components includes at least one electronic hardware component.

21. The system of claim 20 wherein the receiving network node is one of a router, a gateway, a switch, a virtual private network concentrator, a modem, a wireless access point, a bridge, a hub, a repeater, a firewall, a proxy server, and an application for relaying data units.

22. The system of claim 20 wherein the corresponding data unit is the received data unit.

23. The system of claim 20 wherein the corresponding data unit is one of a link layer data unit, a network layer data unit, an application layer data unit, a transport layer data unit, and a session layer data unit.

24. The system of claim 20 wherein the received data unit identifies a destination node via at least a portion of one of an Internet protocol (IP) network address, a symbolic name corresponding to an IP address, and a media access control (MAC) address.

25. The system of claim 20 wherein the routing engine component is configured to determine a measure of energy by determining at least one of a data throughput, a bit error rate (BER), a number of retries, a number of dropped packets, and a number of collisions.

26. The system of claim 20 wherein the routing engine component is configured to determine a measure of energy by measuring energy consumed associated with data transmission including energy consumption resulting from any unsuccessful data transmissions.

27. The system of claim 20 wherein the routing engine component is configured to determine a measure of energy by receiving routing energy information from another network node.

28. The system of claim 27 wherein the routing engine component is configured to determine a measure of energy by implementing or modifying at least one of a data routing policy, a data routing table, and a data routing decision based on the received routing energy information.

29. The system of claim 20 wherein the routing engine component is configured to determine a measure of energy by receiving routing energy information with the received data unit.

30. The system of claim 20 wherein the routing engine component is configured to determine a measure of energy by receiving routing energy information in a message received according to a routing protocol.

31. The system of claim 30 wherein the routing protocol includes at least one of a link-state protocol, a distance vector protocol, a path vector protocol, and a label switching protocol.

32. The system of claim 20 wherein the forwarding engine component is configured to determine whether to transmit a data unit corresponding to the received data unit by comparing the determined measure of energy to a threshold amount and determining whether to transmit a data unit corresponding to the received data unit along any one of the plurality of destination network paths based on the comparison.

33. The system of claim 20 wherein the forwarding engine component is configured to transmit the data to a next one of the respective plurality of network nodes along the one of the plurality of destination network paths by:
identifying at least a portion of a network address associated with a next hop in the one of the plurality of destination network paths based on the measure of energy determination; and
identifying the one of the plurality of destination network paths based on the identified at least a portion of the network address.

34. The system of claim 33 wherein the forwarding engine component is configured to configure a communication channel for transmitting the data unit from a received storage location along the one of the plurality of destination network paths.

35. The system of claim 33 wherein the forwarding engine component is configured to discard the corresponding data unit.

36. The system of claim 1 wherein the corresponding data unit is at least one of unicast data unit, a multicast data unit, and a broadcast data unit.

37. The system of claim 33 wherein the forwarding engine component is configured to transmit the data to a next one of the respective plurality of network nodes along the one of the plurality of destination network paths by:
associating the corresponding data unit with a priority based on the measure of energy; and
determining a position in a transmission queue associated with the one of the plurality of destination network paths based on the associated priority.

38. A computer readable medium storing a computer program, executable by a machine, for sending data units based on a measure of energy, the computer program comprising executable instructions for:
receiving, at a receiving network node, a data unit sent to a destination node;
determining a measure of energy needed to successfully send data to the destination node for each of at least one of a plurality of destination network paths available for routing the data to the destination node, each destination network path including a respective plurality of nodes having an energy expenditure and an effective rate of data transmission contributing to the measure of energy needed to successfully send data to the destination node;
determining, based on the determined measure of energy needed to successfully send data, whether to transmit a data unit corresponding to the received data unit along any one of the plurality of destination network paths; and
responsive to a determination to transmit the corresponding data unit along one of the plurality of destination network paths, transmitting the corresponding data unit to a next one of the respective plurality of network nodes along the one of the plurality of destination network paths.
